(19) United States
(12) Patent Application Publication
(10) Pub. No.: US 2011/0178872 A1
(43) Pub. Date: Jul. 21, 2011

(54) KEYWORD ADVERTISING METHOD BASED ON COLLECTING OF USERS SEARCH INTENTION

(75) Inventor: Tsung-Hao LEE, Taipei City (TW)

(73) Assignee: FIRST WEB LIMITED, Taipei City (TW)

(21) Appl. No.: 12/759,705

(22) Filed: Apr. 14, 2010

(30) Foreign Application Priority Data
Jan. 15, 2010 (TW) 99101082

(51) Int. Cl. G06Q 30/00; G06Q 10/00

(52) U.S. Cl. 705/14.54

(57) ABSTRACT

An advertising method is disclosed. The method includes gathering a keyword of an http referrer in a uniform resource locator. The keyword is stored in a database. Then, a relationship between this uniform resource locator and the keyword is built. Finally, when this uniform resource locator is displayed again, the advertisements corresponding to these collected keywords are displayed together.

### RELATED APPLICATIONS

This application claims priority to Taiwan Application Serial Number 99101082, filed Jan. 15, 2010, which is herein incorporated by reference.

### BACKGROUND

1. Field of Invention

The present invention relates to an advertising method. More particularly, the present invention relates to an advertising method based on collecting of user search intension.

2. Description of Related Art

Keyword advertisement is a kind of advertisement related to a search word in Internet. That is, Keyword advertisement is a form of advertisement exclusively displayed in a search result page when a user performs a search using a search string containing a keyword which an advertiser has purchased. Since the keyword advertisement tends to show advertisement contents to only the people having interest in a specific product or a specific item, the keyword advertisement tends to be a more effective means of advertising and may increase the click rate of the advertisement.

According to a typical keyword advertisement, a search engine extracts a search result from a database using a search word received by a search page from a user terminal, generates a search result page with respect to the search result, and provides the user terminal with the search result page. Then, the user can click a linkage provided by the search result page to link to a Uniform Resource Locator to browse a webpage.

However, according to the typical keyword advertisement, the search result page only provides the linkage related to the search word. In other words, when a search result page is searched based on a search word, “car”, even though the main contents of a webpage is about travel, the travel advertisement linkage is not provided in this webpage because this webpage is not searched based on a search word, “travel”. On the other hand, a search engine is involved in the typical keyword advertisement. In other words, when a user link to a Uniform Resource Locator to browse a webpage that is not searched by a search engine, there is not any keyword advertisement linkage provided by this web-page.

Therefore, an advertising method that can resolve the above problems is required.

### SUMMARY

The goal of this embodiment is to provide an advertising method. The method includes gathering a keyword of an http referrer in a uniform resource locator. The keyword is stored in a database. Then, a relationship between this uniform resource locator and the keyword is built. Finally, when this uniform resource locator is displayed again, the advertisements corresponding to these collected keywords are displayed together.

In an embodiment, the method further comprises to count the importance of the keyword, set at least an important indicator and display the advertisements corresponding to the keywords based on the important indicator and the counted importance of each of the keywords.

As aforementioned, even though a uniform resource locator is not searched by a search engine, all advertisements related to search words that have been used to search the Uniform Resource Locator are still displayed. In other words, the keyword advertisement can be linked to all webpages. Accordingly, the claimed invention can help advertiser to enlarge advertising range and help the user to enlarge search advertisement range. Therefore, the claimed invention can reach a win-win result.

### BRIEF DESCRIPTION OF THE DRAWINGS

The invention can be more fully understood by reading the following is detailed description of the embodiment, with reference made to the accompanying drawings as follows:

FIG. 1 illustrates a flow chart to collect keyword for searching advertisement according to an embodiment.

FIG. 2 is a flow chart to search the advertisement using the keywords gathered in FIG. 1.

### DETAILED DESCRIPTION

The method includes gathering a keyword of an http referrer in a uniform resource locator. The keyword is stored in a database. Then, a relationship between this uniform resource locator and the keyword is built. Finally, when this uniform resource locator is displayed again, the advertisements corresponding to these collected keywords are displayed together. In other words, according to the claimed invention, when this uniform resource locator is displayed again, all advertisements related to search words that have been used to search the Uniform Resource Locator are displayed together. On the other hand, according to the claimed invention, a keyword is stored in a database and a relationship between this uniform resource locator and the keyword is built. Therefore, it is not necessary for the claimed invention to use a search engine to build a relationship between this uniform resource locator and the keyword. That is, even though a uniform resource locator is not searched by a search engine, all advertisements related to search words that have been used to search the Uniform Resource Locator are still displayed. Accordingly, the claimed invention can help advertiser to enlarge advertising range and help the user to enlarge search advertisement range. Therefore, the claimed invention can reach a win-win result.

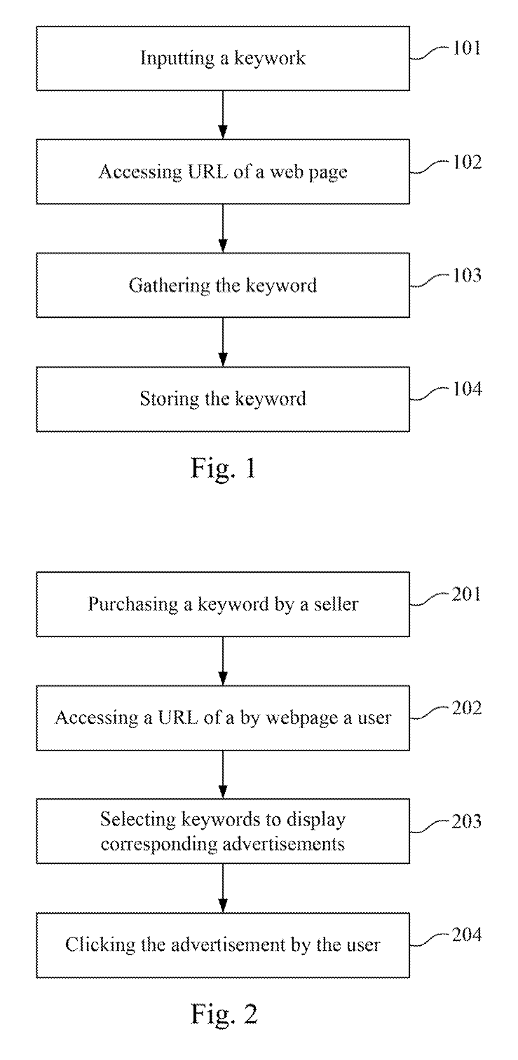

FIG. 1 illustrates a flow chart to collect keyword for searching advertisement according to an embodiment. In step 101, a user inputs a keyword in a search engine. That is, a user inputs a keyword to search a product or a document he wants in a search engine, such as Yahoo or Google. Then, a search result page is generated with respect to the keyword. Then, the user can click a linkage provided by the search result page to link to a Uniform Resource Locator to browse content of a webpage. In step 102, this Uniform Resource Locator clicked by the user is accessed.

In step 103, this invention gathers this keyword. In step 104, the keyword is stored to a database based on HTTP referrer in a uniform resource locator. In an embodiment, the keywords gathered from step 103 are analyzed to link with corresponding webpages. In an embodiment, the gathered keywords are sorted based on the number of the keyword being searched in step 104.

HTTP referrer is an HTTP header field that has Uniform Resource Locator (URL) format. By checking the referrer, the new page can see where the request came from. For example, the HTTP referrer (or referring page) is the Uniform Resource Locator of the previous webpage from which a link was followed. By checking the referrer, this step 103 gathers the keyword that is inputted by a user in previous webpage. For a webpage, the contents of this webpage can contain different keywords. That is, a Uniform Resource Locator of this webpage can be searched by different keywords. For example, a webpage A that introduces a car A can also introduce a travel A. Therefore, this Uniform Resource Locator of this webpage can be searched by the keyword “car A” and “travel A”.

Therefore, after a user inputs a keyword, “car A”, in a search engine A to search out a Uniform Resource Locator of this webpage A in step 101 and this Uniform Resource Locator of the webpage A is accessed in step 102, this keyword, “car A”, is gathered and is stored to a database based on HTTP referrer of the uniform resource locator of the previous page, search engine A, in step 103. On the other hand, after a user inputs a keyword, “travel A”, in a search engine A to search out a Uniform Resource Locator of this webpage A in step 101 and this Uniform Resource Locator of the webpage A is accessed in step 102, this keyword, “travel A”, is gathered and is stored to a database based on HTTP referrer of the uniform resource locator of the previous page, search engine A, in step 103. In other words, this Uniform Resource Locator of the webpage A can be searched out by the keyword “car A” or “travel A”.

FIG. 2 is a flow chart to search the advertisement using the keywords gathered in FIG. 1.

In step 201, the advertisers purchase keywords. When a user wants to buy a product, such as a TV, he can input a keyword, TV, to search documents about TV to check comment and based on this comment to select a special product. In this case, the keyword is TV. The TV sellers, the advertisers, purchase the keyword “TV” to promote their products. Accordingly, when the to comment document is displayed in a buyer's display, the advertisement linkage of the seller is also displayed in the buyer's display.

In step 202, a user accesses this Uniform Resource Locator of the webpage. In this step, no matter this Uniform Resource Locator of this webpage is accessed directly or is accessed through a search engine by the user, corresponding keyword advertisement linkages are provided in this webpage based on keywords stored in the database. In an embodiment, when a user inputs a keyword, “car A”, in a search engine A to search out this webpage A, corresponding keyword advertisement linkages, including “car A” and “travel A” advertisements, are provided in this Uniform Resource Locator of this webpage because both the keywords, “car A” and “travel A” have been gathered from this webpage A based on HTTP referrer of the uniform resource locator of the previous page in step 102 to 104. That is, this webpage A corresponds to “car A” and “travel A” advertisements. However, in a typical keyword advertisement, only “car A” advertisement is provided in this webpage A.

Moreover, in another embodiment, when a Uniform Resource Locator of a webpage has been searched by different keywords, that is, many advertisements are corresponded to this Uniform Resource Locator of this webpage, the claimed invention can filter these keywords to select some of these keywords to provide corresponding keyword advertisement linkage in this webpage. In an embodiment, an importance indicator is used to decide which keyword advertisement should be displayed in this webpage. In an embodiment, the importance indicator is a threshold number. Each of the gathered keywords is counted to decide its importance. For example, the gathered keywords are sorted based on the number of the keyword being searched in step 104. The keywords whose number are larger than the threshold value are important keywords. That is, the advertisements linkages of the keywords whose number are larger than the threshold value are displayed in the webpage. In contrary, the advertisements linkages of the keywords whose number are less than the is threshold value are not displayed in the webpage. In another embodiment, the keyword price bought by the advertiser is used to decide whether or not the advertisement linkage is displayed in the webpage.

Finally, in step 204, the user can select the advertisement he wants.

Accordingly, a keyword is stored in a database and a relationship between this uniform resource locator and the keyword is built. Therefore, it is not necessary for the claimed invention to use a search engine to build a relationship between this uniform resource locator and the keyword. That is, even though a uniform resource locator is not searched by a search engine, all advertisements related to search words that have been used to search the Uniform Resource Locator are still displayed. Accordingly, the claimed invention can help advertiser to enlarge advertising range and help the user to enlarge search advertisement range. Therefore, the claimed invention can reach a win-win result.

Although the present invention has been described in considerable detail with reference to certain embodiments thereof, other embodiments are possible. Therefore, it will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A keyword advertising method, comprising:
gathering a keyword of an http referrer in a uniform resource locator, wherein each of the keywords is used to search the uniform resource locator;
storing the keywords in a database;
building a relationship between the uniform resource locator and each of the keywords; and
displaying the advertisements corresponding to the keywords when this uniform resource locator is accessed.

2. The method of claim 1, further comprising to count an importance of each of the keywords.

3. The method of claim 1, further comprising:
setting at least an important indicator;
displaying the advertisements corresponding to the keywords based on the important indicator and the counted importance of each of the keywords.

4. The method of claim 3, further comprising to display the advertisements corresponding to the keywords when this uniform resource locator is accessed.
